(19) United States
(12) Patent Application Publication
(10) Pub. No.: US 2024/0292453 A1
(43) Pub. Date: Aug. 29, 2024

(54) METHOD AND APPARATUS FOR MANAGING COMMUNICATION DELAY IN MOBILE COMMUNICATION SYSTEM

(71) Applicant: Samsung Electronics Co., Ltd., Suwon-si, Gyeonggi-do (KR)

(72) Inventors: Sungryeul RHYU, Suwon-si (KR); Eric YIP, Suwon-si (KR)

(21) Appl. No.: 18/440,274

(22) Filed: Feb. 13, 2024

(30) Foreign Application Priority Data
Feb. 14, 2023 (KR) 10-2023-0019587
Jan. 16, 2024 (KR) 10-2024-0006623

(51) Int. Cl. H04W 74/0808; H04W 74/04; H04W 74/08

(52) U.S. Cl. CPC H04W 74/0808; H04W 74/04; H04W 74/0875

(57) ABSTRACT

The disclosure relates to a fifth generation (5G) or sixth generation (6G) communication system for supporting a higher data transmission rate. A method by a first user equipment (UE) managing communication delay in a communication system is provided. The method includes receiving, from a server, scheduling information for generating communication delay information upon transmitting media to a second UE, measuring a communication delay with the first UE and the second UE based on the scheduling information, generating the communication delay information based on the measured communication delay, and transmitting, to the server, the communication delay information.

### CROSS-REFERENCE TO RELATED APPLICATION(S)

This application is based on and claims priority under 35 U.S.C. § 119(a) of a Korean patent application number 10-2023-0019587, filed on Feb. 14, 2023, in the Korean Intellectual Property Office, and of a Korean patent application number 10-2024-0006623, filed on Jan. 16, 2024, in the Korean Intellectual Property Office, the disclosure of each of which is incorporated by reference herein in its entirety.

### BACKGROUND

### 1. Field

The disclosure relates to a method and apparatus for managing a signal delay between a user equipment (UE) and a server or between UEs in a mobile communication system.

### 2. Description of Related Art

Fifth generation (5G) mobile communication technologies define broad frequency bands such that high transmission rates and new services are possible, and can be implemented not only in “Sub 6 gigahertz (GHZ)” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Meanwhile, it is defined as tethering that a UE to receive media extends the service transmission path through wireless connection with a separate external device for consuming media in reception and consumption of a media service provided through communication between a UE and a server based on a mobile communication system. A need arises for ensuring quality of service (QOS) by maintaining the delay of the path related to tethering of the entire extended service transmission path.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for managing a transmission delay between a UE and a server or between UEs in a communication system.

Another aspect of the disclosure is to provide a method and apparatus in which a UE (tethering device) connected to a mobile communication network measures the transmission delay with an accessory UE (tethered device) connected to the UE (tethering device).

Another aspect of the disclosure is to provide a method and apparatus in which a mobile communication network server transmits delay-related management information with an accessory UE (tethered device) to a UE (tethering device).

Additional aspects will be set forth in part in the description which follows and, in part, will be apparent from the description, or may be learned by practice of the presented embodiments.

In accordance with an aspect of the disclosure, a method performed by a first user equipment (UE) managing communication delay in a mobile communication system is provided. The method includes receiving, from a server, scheduling information for generating communication delay information upon transmitting media to a second UE, measuring a communication delay with the first UE and the second UE based on the scheduling information, generating the communication delay information based on the measured communication delay, and transmitting to the server, the communication delay information.

In accordance with another aspect of the disclosure, a method performed by a server managing communication delay in a mobile communication system is provided. The method includes transmitting, to a first user equipment (UE), scheduling information for generating communication delay information upon transmitting media to a second UE through the first UE and receiving the communication delay information from the first UE. The communication delay information is generated based on a communication delay with the first UE and the second UE. The communication delay information is measured based on the scheduling information.

In accordance with another aspect of the disclosure, a first user equipment (UE) managing communication delay in a mobile communication system is provided. The first UE includes a transceiver and at least one processor. The at least one processor may receive, from a server, scheduling information for generating communication delay information upon transmitting media to a second UE, measure a communication delay with the first UE and the second UE based on the scheduling information, generate the communication delay information based on the measured communication delay, and transmit, to the server, the communication delay information.

In accordance with another aspect of the disclosure, a server managing communication delay in a mobile communication system is provided. a transceiver and at least one processor. The at least one processor may transmit, to a first user equipment (UE), scheduling information for generating communication delay information upon transmitting media to a second UE through the first UE and control to receive the communication delay information from the first UE. The communication delay information is generated based on a communication delay with the first UE and the second UE. The communication delay information is measured based on the scheduling information.

In accordance with another aspect of the disclosure, one or more non-transitory computer-readable storage media storing one or more computer programs including computer-executable instructions that, when executed by one or more processors of a first user equipment (UE), cause the first UE to perform operations are provided. The operations include receiving, by the first UE from a server, scheduling information for generating communication delay information upon transmitting media to a second UE, measuring, by the first UE, a communication delay with the first UE and the second UE based on the scheduling information, generating, by the first UE, the communication delay information based on the measured communication delay, and transmitting, by the first UE to the server, the communication delay information.

The method and apparatus according to an embodiment may provide a guaranteed quality of service (QOS) for an entire service transmission path including an extended service transmission path in reception and consumption of a media service provided through communication between a server and a UE and between accessory UEs connected to the UE in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view schematically illustrating a communication system configuration according to an embodiment of the disclosure;

FIG. 2A is a flowchart illustrating an operation of measuring a tethered delay in a communication system according to an embodiment of the disclosure;

FIG. 2B is a flowchart illustrating an operation in which a UE (tethering device) reports quality of experience (QoE) metrics to a mobile communication network server according to an embodiment of the disclosure;

FIG. 3 is a view illustrating an interface between an interface device connected to a UE (tethering device) and an internal function of the UE (tethering device) according to an embodiment of the disclosure;

FIG. 4 is a view illustrating a round trip time (RTT) and delay between entities constituting a communication system when an accessory UE (tethered device) is connected to a UE (tethering device) according to an embodiment of the disclosure;

FIG. 5 is a view illustrating a round trip time (RTT) and delay between entities constituting a communication system when an accessory UE (tethered device) is not connected to a UE (tethering device) according to an embodiment of the disclosure;

FIG. 6 is a view illustrating a communication method considering a tethered delay according to an embodiment of the disclosure;

FIG. 7 is a block diagram illustrating a configuration of a UE in a communication system according to an embodiment of the disclosure; and

FIG. 8 is a block diagram illustrating a configuration of a server in a communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification. When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

Hereinafter, a base station (BS) is an entity that performs resource allocation of a UE, and may be at least one of a gNode B, eNode B, Node B, (or xNode B (where x is an alphabetic character including g and e)), a radio access unit, a base station controller, a satellite, an airborne, or a node on network. The user equipment (UE) may include a mobile station (MS), vehicle, satellite, airborne, cellular phone, smartphone, computer, or multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Additionally, a sidelink (SL) meaning a radio transmission path of a signal transmitted from a UE to another UE may exist.

Although long term evolution (LTE), LTE-advanced (LTE-A), or 5G systems may be described below as an example, the embodiments may be applied to other communication systems having a similar technical background or channel pattern. For example, embodiments of the disclosure may also encompass 5G-advance or NR-advance or 6th generation mobile communication technology (6G) developed after 5G mobile communication technology (or new radio (NR)). The following 5G may be a concept encompassing the legacy LTE, LTE-A and other similar services. Further, the embodiments may be modified in such a range as not to significantly depart from the scope of the disclosure under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, a ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

Wireless communication systems evolve beyond voice-centered services to broadband wireless communication systems to provide high data rate and high-quality packet data services, such as 3rd generation partnership project (3GPP) high speed packet access (HSPA), long term evolution (LTE) or evolved universal terrestrial radio access (E-UTRA)), LTE-advanced (LTE-A), LTE-pro, 3GPP2 high rate packet data (HRPD), ultra mobile broadband (UMB), and institute of electrical and electronics engineers (IEEE) 802.16e communication standards.

As a representative example of such broadband wireless communication system, the LTE system adopts orthogonal frequency division multiplexing (OFDM) for downlink and single carrier frequency division multiple access (SC-FDMA) for uplink. Uplink means a wireless link where the UE transmits data or control signals to the base station, and download means a wireless link where the base station transmits data or control signals to the UE. Such multiple access scheme may typically allocate and operate time-frequency resources carrying data or control information per user not to overlap, i.e., to maintain orthogonality, to thereby differentiate each user's data or control information.

Post-LTE communication systems, e.g., 5G communication systems, are required to freely reflect various needs of users and service providers and thus to support services that simultaneously meet various requirements. Services considered for 5G communication systems include, e.g., enhanced mobile broadband (eMBB), massive machine type communication (MMTC), and ultra reliability low latency communication (URLLC).

‘Media component’ may denote an element that constitutes media in a media service. For example, the media may include movies, graphics, augmented reality (AR), virtual reality (VR), mixed reality (MR) services, games, music, etc. The media components may include videos, audios, subtitles, images, graphics, metadata, user interactions, poses, haptics, etc.

‘Media profile’ may denote a combination of setting values for various standards, such as resolution, codec, bitrate, format, and quality in a media service or each media component that constitutes the media service. The UE may determine whether a media service or media component is playable on the UE or whether it is processible by the UE within a required time before receiving the media service or media component to be provided by the server, using the media profile.

‘Media frame’ may denote one sheet of image in the case of video or a piece of content reproduced during presentation duration with a presentation timestamp when output is intended, such as a sound during a unit time in the case of audio.

‘Tethering’ may mainly denote access by one UE to the Internet through a communication function of another UE. The tethering technology in the background of the disclosure is tethering connection between a tethering UE (tethering device) and an accessory UE (tethered device) and an information exchange method for providing service between a UE and a mobile communication network for the tethering connection.

The ‘tethering device’ (hereinafter, UE) may connect to the mobile communication network to receive and transmit media constituting the service provided by the server and related data. In the disclosure, ‘UE’ denotes the tethering UE (tethering device) unless specifically limited to another UE.

‘Accessory UE (tethered device)’ denotes a UE connected to the tethering UE (tethering device) to consume all or some media components constituting media. In the disclosure, accessory UE denotes a tethered UE (tethered device) connected to a tethering UE (tethering device).

The connection between the tethering UE (tethering device) and the accessory UE (tethered device) may use wired or wireless connection technology, examples of which may include Wi-Fi, Bluetooth, IoT, or 5G sidelink. In the disclosure, the connection between the UE and the accessory UE is referred to as a non-3GPP access network, but may collectively denote the mobile communication technology used by the UE and all other communication technologies.

Further, hereinafter, the tethering UE (tethering device) may be referred to as a UE (tethering device) or a first UE, and the accessory UE (tethered device) may be referred to as a second UE.

‘Photon’ is a time when light is represented on the user's glasses display in, e.g., augmented reality (AR) technology. In the disclosure, a photon time is applied broadly to include audio and haptic as well as video as media component types to be output. In other words, as an example, in an example such as ‘pose to photon delay time,’ the time when audio is output as a result of the user's pose input may also be treated as a pose to photon delay time.

When the UE (tethering device) connected with the accessory UE (tethered device) is connected to the mobile communication network, the connection between the UE (tethering device) and the mobile communication network is provided by the mobile communication network and its quality is guaranteed while the connection between the UE (tethering device) and the accessory UE (tethered device) relies on the tethering connection technology between the UE (tethering device) and the accessory UE (tethered device). From a perspective of an application provider who wants to provide a service through the mobile communication network, when the user of the UE (tethering device) intends to receive the service using the accessory UE (tethered device), a period during which transmission quality is not guaranteed may occur.

Further, when the application provider intends to provide a service with temporal requirements (e.g., transmission speed or allowed delay limits) between the accessory UE (tethered device) and the server, there is needed a method for identifying the transmission time of the tethered period of the entire transmission required, required time according to the performance of the UE (tethering device), and transmission time by the mobile communication network.

Meanwhile, the UE (tethering device) is required to make the maximum allowed delay time and resultant processing method differ for media transmission depending on the context processed by the accessory UE (tethered device), i.e., the meaning of the content. According to the five human senses, sight, hearing, touch, and the like have different allowed delay limits, so there is information that is sensitive to delay and information that is not. When the accessory UE (tethered device) receives only part of the five senses and then outputs the same, abnormal service reproduction may occur due to a difference between connection technologies between accessory UEs (tethered devices) and its resultant delay difference. Accordingly, there are required a method for a server to specify a maximum allowed delay time for the medial, media component, and each accessory UE (tethered device) and a method for a UE (tethering device) to report the delay time occurring in the accessory UE (tethered device).

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

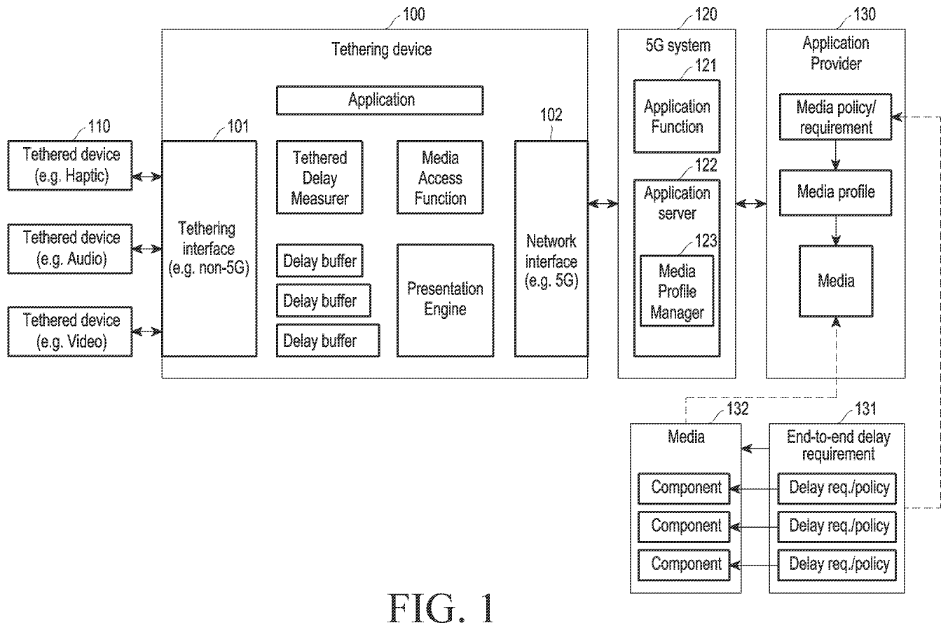

FIG. 1 is a view schematically illustrating a communication system configuration according to an embodiment of the disclosure.

Referring to FIG. 1, a communication system may include a UE (tethering device) 100, an accessory UE (tethered device) 110, a mobile communication network system (5G system) 120, and an application provider 130.

The UE (tethering device) 100 may include a tethering interface 101 that communicates with the accessory UE (tethered device) 110, i.e., a non-3GPP access network interface, which may refer to a module that communicates using a communication technology different from the mobile communication technology used by the UE.

The UE (tethering device) 100 may include a network interface 102 communicating with the mobile communication network system (5G system) 120.

The mobile communication network system (5G system) 120 may include an application function 121 and an application server (hereinafter, server) 122.

The application provider 130 may provide media and set an end-to-end delay requirement 131 for the entire media 132 or each media component. The end-to-end delay requirement 131 may include at least one of a maximum allowed delay time and an over-delay policy. The application provider 130 may transmit the end-to-end delay requirement 131 for the media 132 or the media component to the mobile communication network system (5G system) 120 in the form of metadata when the media is transmitted. Thereafter, the mobile communication network system (e.g., the 5G system) 120 and the UE (tethering device) 100 and the accessory UE that execute the corresponding media may measure the transmission delay for establishing a session meeting the corresponding requirement, configure, e.g., a media profile, UE performance, 5G network quality of service (QOS), tethering network quality of service (QoS), and tethering network quality of service (QOS), and dynamically change the configuration based on measurements for performance and transmission status even after a session is established.

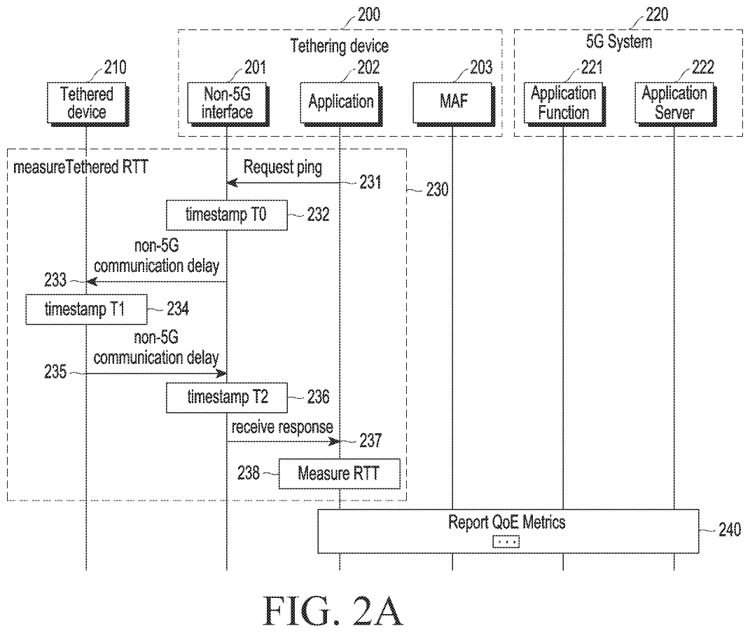

The UE (tethering device) 100 may measure and check the state of the tethering connection between the UE (tethering device) 100 and the accessory UE (tethered device) 110 through data transmission with the accessory UE (tethered device) 110 or through periodic or aperiodic Internet control message protocol (ICMP) ping or timestamp request packet transmission. This includes measuring a communication delay between the UE (tethering device) 100 and the accessory UE (tethered device) 110. Further, the UE (tethering device) 100 may measure the state of the connection between the UE (tethering device) 100 and the accessory UE (tethered device) 110 through an inquiry about the timestamp described in the packets exchanged in the most recent transmission process. When one or more tethering connections are established with one or more accessory UEs (tethered devices) 110, a separate state (e.g., communication delay) may be measured and stored for each connection. A more detailed description will be made later with reference to FIG. 2A.

When a function and performance for the UE (tethering device) 100 to reproduce and consume specific media or a specific media component are set through connection with the accessory UE (tethered device) 110, the UE (tethering device) 100 may request, receive, and consume media provided by the application provider 130. The connection between the UE (tethering device) 100 and the application provider 130 may be mediated by the mobile communication network system (5G system) 120, and a session for transmission may be established after the server 122 determines whether it is possible to consume the service by exchanging information about the function and performance of the UE in a predefined format.

In terms of transmission, the mobile communication network system (5G system) 120 may identify an end-to-end delay-related requirement for a media service to be provided by being delegated by the application provider 130, allocate a resource of the server 122 to meet the end-to-end delay-related requirement, and allocate a quality of service (QOS) between the UE (tethering device) 100 and the mobile communication network system (5G system) 120. From a perspective of the mobile communication network system (5G system) 120, it is impossible to guarantee whether or not a tethering connection is made between the UE (tethering device) 100 and the accessory UE (tethered device) 110 after a network transmission path to the UE (tethering device) 100 or QoS for the corresponding connection, so that the mobile communication network system (5G system) 120 may transfer the delay-related requirement of the application provider 130 for media to the UE (tethering device) 100 and delegate the UE (tethering device) 100 to manage the tethering connection within a range for consuming media based on the delay management requirement.

The UE (tethering device) 100 may operate a limit value of the delay buffer for the media and the media component differently for each media component based on the received delay-related requirement, and manage a policy for a case of exceeding the maximum limit of the allowed delay for each tethering connection for the media component and the corresponding accessory UE (tethered device) 110.

The UE (tethering device) 100 may report the statistical information about the communication delay information for the tethering connection of the UE periodically, aperiodically, or at the request of the server, and the media profile manager 123 of the server 122 may determine to maintain the use of the currently provided media profile or to change to another media profile, based on the analysis of the statistics.

When media-based 1:1 or 1:many communication between UEs, e.g., an augmented reality (AR) conversational service is performed, the UE of the first user and the UE of the second user participating in the conversation may correspond to the UE (tethering device) 100 and the application provider 130, respectively, of FIG. 1, and images, voices, spatial identification information, haptic, text, and other data, which are media obtained and transmitted by the second user UE, are transmitted through the server 122. The UE of the second user may generate a media profile and an entire transmission delay requirement for appropriately consuming the transmitted data, and may determine, under mutual agreement, transmission session establishment using a profile identified and supported by a uniform resource name (URN) and the entire delay requirement among previously agreed expression forms before performing media-based communication between UEs.

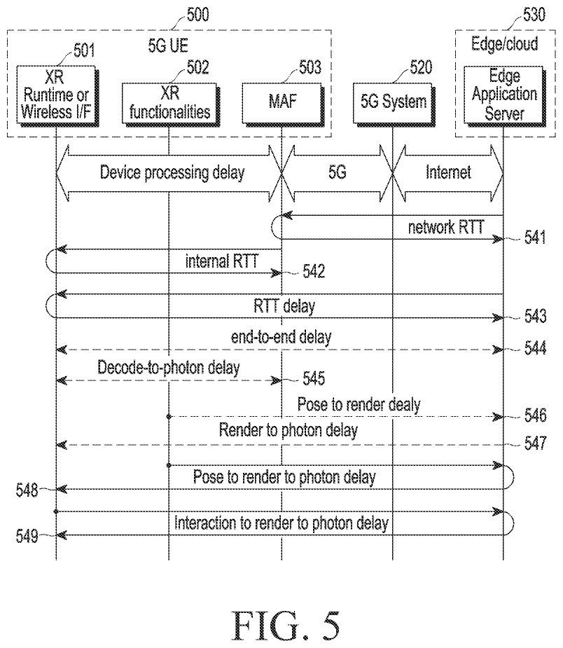

The application provider 130 may set the maximum allowed delay time (maxAllowedDelay) for the media component with a method for specifying delay requirements considering that the UE makes a tethering connection with the accessory UE. The maximum allowed delay time (maxAllowedDelay) is a reference value that is a boundary of policy application when the UE transmits a corresponding media component to the accessory UE. When the tethered delay value generated in the communication between the accessory UE and the UE is smaller than the maximum allowed delay time (maxAllowedDelay), the UE does not need to apply a separate policy, and when the tethered delay value is larger than maxAllowedDelay, the server 122 specifies a policy to be processed by the UE for the corresponding media component. The policy includes drop, correct, rest, and ignore, which are described below in detail with reference to FIG. 6. The tethered delay value may be tetheredDelay, tethered-connectionRTT, or the sum of tethered-internalRTT and tethered-connectionRTT of Table 1 to be described below.

The server 122 may set different delay-related requirements according to the media to be transmitted to the UE (tethering device) 100, the media components constituting the media, the type of the media component, or the like. The delay-related requirement may include at least one of a maximum allowed delay time (maxAllowedDelay) or an over-delay policy. The delay requirement may include priority information between media components.

FIG. 2A is a flowchart illustrating an operation of measuring a tethered delay in a communication system according to an embodiment of the disclosure.

Referring to FIG. 2A, FIG. 2A illustrates an example 230 of measuring a tethered round trip time (tetheredRTT) between the UE (tethering device) 200 and the accessory UE (tethered device) 210. The application 202 of the UE (tethering device) 200 requests the non-3GPP access network interface 201 to transmit a ping message to measure the tethered delay 231, and the UE (tethering device) 200 transmits an Internet control message protocol (ICMP) ping or an ICMP timestamp request message to the accessory UE (tethered device) 210.

The timestamp value may be recorded, as T0, in the header of the request packet at the time when the non-3GPP access network interface 201 of the UE generates the ICMP ping or ICMP timestamp request message 232. Thereafter, when the UE (tethering device) 200 transmits the ICMP ping or ICMP timestamp request message to the accessory UE (tethered device) 210, a non-3GPP access network delay 233 occurs, and the accessory UE (tethered device) records the timestamp value of T1 in the header of the response packet 234 and transmits the response message to the UE (tethering device) 200, in which case a non-3GPP access network delay 233 may occur 235.

Thereafter, the non-3GPP access network interface 201 of the UE (tethering device) 200 may complete the measurement by calculating the round trip time (RTT) (or round trip transmission delay time) (=T2−T0) between the accessory UE (tethered device) 210 and the UE (tethering device) 200 and the tethered delay which is a single transmission delay time (=T2−T1), and tethered UE internal delay (=T2−T0−2×(T2−T1)) based on the timestamp T2 236 which is the received response time 238 of the response packet 238. Thereafter, an operation 240 in which the UE (tethering device) 200 reports quality of experience (QoE) metrics to the mobile communication network system (5G system) 220 is described below with reference to FIG. 2B.

FIG. 2B is a flowchart illustrating an operation in which a UE (tethering device) reports quality of experience (QoE) metrics to a mobile communication network server according to an embodiment of the disclosure.

Referring to FIG. 2B, the UE (tethering device) 200 may generate a quality of experience (QoE) metrics report and report it to the server 222, periodically, aperiodically, or at the request of the application server (hereinafter, server) 222 of the mobile communication network system (5G system) 220.

The application 202 of the UE (tethering device) 200 may request the quality of experience (QoE) metrics report from the media access function (MAF) 203 241.

The UE (tethering device) 200 (e.g., the media access function (MAF) 203) may generate a quality of experience metrics (QoE) report 242. The UE (tethering device) 200 (e.g., the media access function (MAF) 203) may transmit the QoE matrix report to the application function 221 or the server 222 of the mobile communication network system (5G system) 220 243.

Hereinafter, the tethered delay, tethered RTT information, and the like that may be included in the QoE matrix report are described.

The UE (tethering device) receiving and consuming a media service includes information related to the tethered delay as shown in Table 1, in the round trip time (RTT) report item in the quality of experience (QoE) metrics report which is a service quality report reported from the UE to the server when the accessory UE is connected, and there is a media component consumed using the same.

### QoE Metrics Report Scheme

TABLE 1

```
QoE metrics
  Round trip time
    NetworkRTT
    InternalRTT
    Tethered-connectionRTT
    Tethered-internalRTT
  Delay
    Tethered-delay
    End-to-end-delay
    Decode-to-IF1-delay
    Decode-to-photon-delay
    Pose-to-render-delay
    Render-to-photon-delay
    Pose-to-render-to-photon-delay
    Interaction-to-render-to-photon-delay
  TetheredDeviceInfo
```

NetworkRTT may denote a network communication delay required to complete reception of a result after transmitting data between the server and the UE.

InternalRTT may denote a UE internal processing delay required to complete reception of a result after transmitting data between the server and the UE.

Tethered-connectionRTT may denote tethered connection communication delay required to complete reception of a result after transmitting data between the UE and the accessory UE.

Tethered-internalRTT may denote an internal processing delay of the accessory UE required to complete reception of a result after transmitting data between the UE and the accessory UE.

The reporting unit of the QoE metrics report is referred to as a vector, and may be reported for each media component being consumed by the UE. When only two vectors of NetworkRTT and InternalRTT are present in the report of one media component, it may be determined that the corresponding media component is consumed by the UE. When there are four vectors of NetworkRTT, InternalRTT, Tethered-connectionRTT, and Tethered-internalRTT in the report of another media component, it may be determined that the corresponding media component is consumed by the accessory UE.

Tethered-delay may denote a unidirectional delay time that occurs when a signal is transmitted between the UE and an accessory UE.

When one or more accessory UEs are connected and tethered delays of different values occur, the accessory UE information (TetheredDeviceInfo) is described as shown in Table 2.

Tethered device information scheme

TABLE 2

```
TetheredDeviceInfo
  Max-Tethered-connectionRIT
  Max-Tethered-internalRTT
  Max-Tethered-delay
  deviceID[ ]
  mediaComponentID[ ]
```

Max-Tethered-connectionRTT, Max-Tethered-internalRTT, and Max-Tethered-delay in TetheredDeviceInfo may be described as the largest values among Tethered-connectionRTTs, Tethered-internalRTTs, and Tethered-delays of different accessory UEs.

DeviceID and MediaComponentID denote the ID of the accessory UE and the ID of the media component consumed by the corresponding accessory UE. According to an embodiment, when 1,1,2,2 are written in DeviceID and 1,2,3,4 are written in MediaComponentID, it indicates that media components 1,2,3,4 are consumed in device 1 and device 2, respectively.

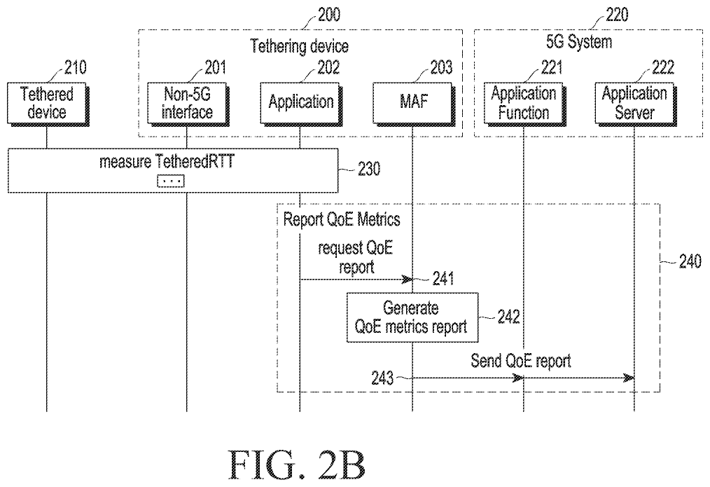

FIG. 3 is a view illustrating an interface between an interface device connected to a UE (tethering device) and an internal function of the UE (tethering device) according to an embodiment of the disclosure.

Referring to FIG. 3, the baseline architecture and the interface between the internal functions may be defined in 3GPP TS 26.119 (Media Capability for AR). In the disclosure, for consumption of media or media components, the connection between the UE (tethering device) 300 and the accessory UE (tethered device) may correspond to the connection between the UE (tethering device) 300 and at least one interface device 310 shown in ellipses outside the UE (tethering device) 300 or the connection between the XR runtime 330 and the XR source management 340 distinguished by interface (IF)-1 320 or between the XR runtime 330 and the presentation engine 350.

In other words, although the UE 300 is logically one object including the accessory UE (tethered device), the UE 300 may be a separate that is physically disconnected and connected through wired or wireless communication.

For a method for reporting a delay generated in the non-3GPP access network connection between the UE and the accessory UE, the delay time due to processing by the UE and the delay time due to the non-3GPP access network connection may be separately measured and reported, which may be shown as in Tables 3 and 4. This may be defined in 3GPP TR 26.565 v0.4.

```
TABLE 3
  6.3.2. Potential solution
  In the segment-by-segment measurement method (clause 6.2.2), the 5G
device (e.g., phone) reports delay between AR gasses and 5G device through the
media access function (MAF). Other 5G functions of the 5G device are not excluded.
The time between the AR glasses and the media access function (MAF) is the sum of
the tethered delay and the time required for operation of the functionality in the UE.
The 5G functionalities of the UE include processing times in the XR runtime,
presentation engine, XR source management, and media access function (MAF). The
server separately receives internal processing delays of the UE and the accessory UE
(tethered device) and a delay occurring in the tethered connection in the delay
between the AR glasses which are the accessory UE (tethered device) and the 5G UE
which is the tethering device. The user plane function (UPF) reports the delay
between the UPF and the application server to the session management function
(SMF).
```

```
TABLE 4
  In the end-to-end measurement method (clause 6.2.3), the AR glasses
measures the end-to-end delay, forwards the measurement to the 5G device. The 5G
device reports it through MAF to the 5G core network.
  The reporting methodology may depend on the tethering architectures. Figure
6.3-1 shows a possible call flow for delay reporting. The reported statistics of the end-
to-end delay may include the mean and standard deviation.
```

The UE (tethering device) may select a media file, i.e., media of appropriate format and quality, which may be received and reproduced through information exchange with the server providing media. The performance of the UE (tethering device) may be represented in the specifications of mounting hardware components, such as central processing unit (CPU), graphical processing unit (GPU), memory, and storage device, but the UE (tethering device) shows the performance of the UE (tethering device) with the processing time required per frame for the media profile suggested by the server. For example, decoding of high efficiency video coding (HEVC)-ultra high definition (UHD) may be expressed as time performance in ms.

When all processes for outputting media to the display from reception of the media through decoding or post-decoding are completed, the time value required for the UE (tethering device) to output the corresponding media frame is derived as a performance index.

In a UE supporting tethering, the processing time of the UE includes a tethered delay (e.g., total UE processing time=UE pure processing time+transmission time+transmission delay+accessory UE processing time). The UE processing time is separately described and reported for the total time or each time component. The UE (tethering device) may measure and report, to the server, the processing performance of the UE, in the form of a required time, for each media profile, and the server may provide guarantee of QoS for the service transmission path including the accessory UE (tethered device) through requirements for delay, policy, and dynamic media profile change, based on the media profile processible by the UE and the required time for each media profile.

When selecting a media profile, the 5G system, service provider, and MTSI UE may make an additional determination according to the time of each component of the UE processing time. For example, when the UE processing time is small, and the transmission delay is small, the server may transmit media whose data size may be made relatively small by post-processing of the UE. When the transmission delay is small, the server may transmit media in which media post-processing may be relatively minimized by the UE.

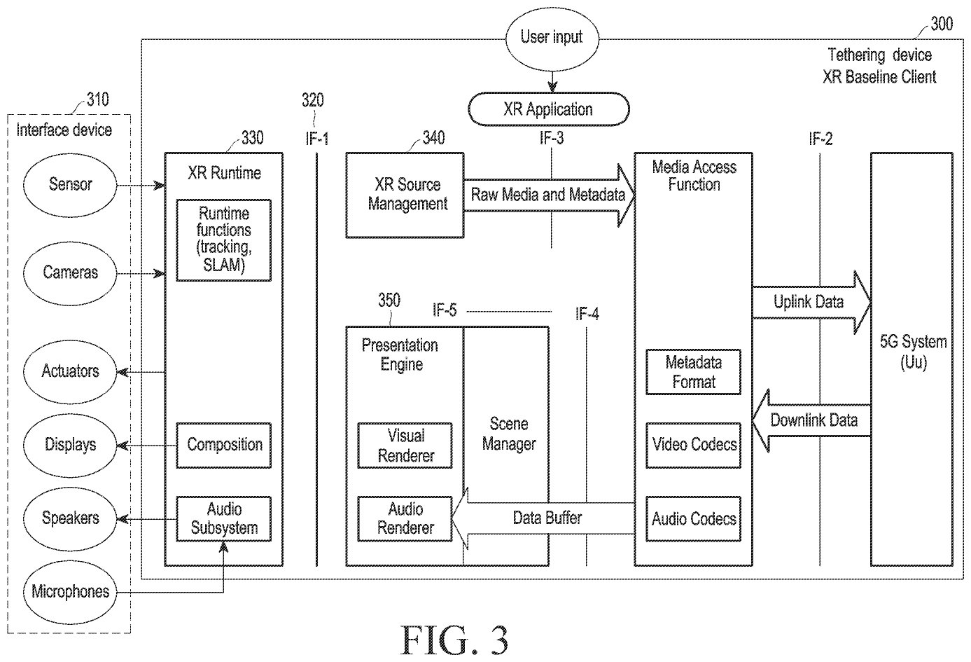

FIG. 4 is a view illustrating a round trip time (RTT) and delay between entities constituting a communication system when an accessory UE (tethered device) is connected to a UE (tethering device) according to an embodiment of the disclosure.

FIG. 4 illustrates a round trip time (RTT) and a delay during communication between components defined in FIG. 3, and a UE (tethering device) (e.g., a 5G UE) 400 may include an XR runtime module (or a wireless interface (IF)) 401, an XR functionalities 402, and a media access function (MAF) 403.

Further, the accessory UE (tethered device) 410 may include an XR runtime module 411 and a wireless interface (IF) 412. The mobile communication network system (5G system) 420 is an edge/cloud model and is connected to an edge application server (hereinafter, server) 430.

To report the QoE metrics of the UE (tethering device) connected with the accessory UE (tethered device) 410, definition of the information may be extended as shown in Table 5. In particular, a delay on the 5G transmission network and a delay on the non-3GPP access network are separately supported. This may be defined in 3GPP TS 26.119 (Media Capability for AR).

```
TABLE 5
  6.X QoE metrics/Tethering capability
  A MeCAR device can report its QoE metrics including the tethered devices,
the delay from tethering connection and its format preferences.
  A MeCAR device support:
  QoE Metrics
    Round Trip Time
    NetworkRTT (may be defined in 16.2.6 of TS 26.114)
    Internal RIT (may be defined in 16.2.6 of TS 26.114)
    Tethered-connectionRTT
    Tethered-internal RIT
    Delay
    Tethered-delay
    End-to-end-delay
    Decode-to-IFI-delay
    Decode-to-photon-delay
    Pose-to-render-delay
    Render-to-photon-delay
    Pose-to-render-to-photon-delay
    Interaction-to-render-to-photon-delay
    Tethered DeviceInfo
    Max-Tethered-connectionRTT
    Max-Tethered-internalRTT
    Max-Tethered-delay
    deviceID[ ]
    mediaComponent ID[ ]
    PoseEstimationID[ ]
    InteractionDevice ID[ ]
    End-to-end delay
    End to end delay
    End to end delay requirements
```

which may be defined in 16.2.6 of TS 26.114

NetworkRTT may denote the network round trip time (RTT) or communication delay in the Internet section and the mobile communication network system (5G) section between the server 430 and the UE (e.g., the media access function (MAF) 403) required for completing reception of a result after data is transmitted between the server 430 and the UE (5G UE) 400 (441). InternalRTT may denote the UE internal processing delay (device processing delay), e.g., the delay between the XR runtime module (or wireless interface (IF)) 401 and the media access function (MAF) 403 inside the UE (5G UE) 400, required for completing reception of a result after data is transmitted between the server 430 and the UE (5G UE) 400 (442).

Tethered-connectionRTT may denote the tethered communication delay 447 in thenon-3GPP access network section between the UE (5G UE) 400 and the accessory UE (e.g., the wireless interface (IF) 412) required for completing reception of a result after data is transmitted between the UE (5G UE) 400 and the accessory UE (tethered device) 410 (443).

Tethered-internalRTT may denote accessory UE internal processing delay, e.g., the delay between the wireless interface (IF) 412 and the XR runtime module 411 inside the accessory UE (tethered device) 410, required for completing reception of a result after data is transmitted between the UE and the accessory UE (444).

RTT without tethered device may denote a delay required for completing a result after data is transmitted between the server 430 and the UE (5G UE) 400, except for the accessory UE (tethered device) 410 (445).

RTT with tethered device may denote the end-to-end delay 448 required for completing reception of a result after data is transmitted between the server 430 and the accessory UE (tethered device) 410 (446).

The UE (5G UE) 400 may measure and describe the time required for processing for each media component.

Decode-to-IF1-delay denotes the time required until it is transferred to the output device in the accessory UE (tethered device) 410 or the output device in the final UE (5G UE) 400 after completing post-processing (e.g., decoding, scene composition, combination, adjustment, etc.) required in the UE to use the corresponding media component. IF1 means the IF-1 interface shown in FIG. 3 (449).

Decode-to-photon-delay denotes the time from reception of the media component to completion of output in the accessory UE (tethered device) 410, with processing inside the accessory UE (tethered device) 410 and the UE (5G UE) 400 and the time required for transmission between the UE (5G UE) 400 and the accessory UE (tethered device) 410 included in the Decode-to-IF1-delay 449 (450).

Pose-to-render-delay includes only the transmission delay time between UE and server and the internal processing time of the UE (5G UE) 400 without including a delay occurring in the tethering connection with the accessory UE (tethered device) 410 when a pose is predicted in the UE (5G UE) 400. It includes a delay occurring the tethering connection with the accessory UE (tethered device) 410 when the pose is predicted in the accessory UE (tethered device) 410 (451).

When PoseEstimationID is specified, the ID of the accessory UE (tethered device) 410 that predicts the pose is specified.

Render-to-photon-delay denotes the time until the rendered media frame undergoes processing between the server 430 and the UE (5G UE) 400 and in the UE (5G UE) 400 and is then transmitted to the accessory UE (tethered device) 410 and output. Photon, although denoting the state in which, e.g., the pixel is visually lighted on, means the time when a media component is output for consumption, such as audio or haptic. When output from the accessory UE (tethered device) 410, the above time includes the tethered delay (452).

Pose-to-render-to-photon-delay includes the pose-to-render-delay and the render-to-photon-delay (453).

Interaction-to-render-to-photon-delay means the time when the user or external interaction event input from the accessory UE (tethered device) 410 is transferred to the server 430 and is received as a result of the media component, and is output to the same or another accessory UE (454).

Hereinafter, an example is described in which when an external interaction event input from the accessory UE is output to another accessory UE, the first accessory UE is the user's stick-type click interface, and the second accessory UE is a binaural speaker device. The interaction event may be triggered on the click interface which is the first accessory UE, and the spatial position and click direction, and strength of the event may be transferred to the server 430, so that a media component may be generated as a door opening sound in a virtual space by the server 430.

The generated media component may be rendered as a spatial sound by the UE (5G UE) 400 according to the spatial positions of the UE (5G UE) 400 and the first accessory UE and the second accessory UE, and may be rendered and output as a binaural sound by the second accessory UE. In this case, the interaction-to-render-to-photon-delay includes the tethered delay time of the first accessory UE and the internal processing time of the UE (5G UE) 400, the transmission delay between the UE (5G UE) 400 and the server, the processing time of the server 430, and the tethered delay time of the second accessory UE.

InteractionDeviceID denotes the ID of the accessory UE generating the interaction event among the accessory UEs.

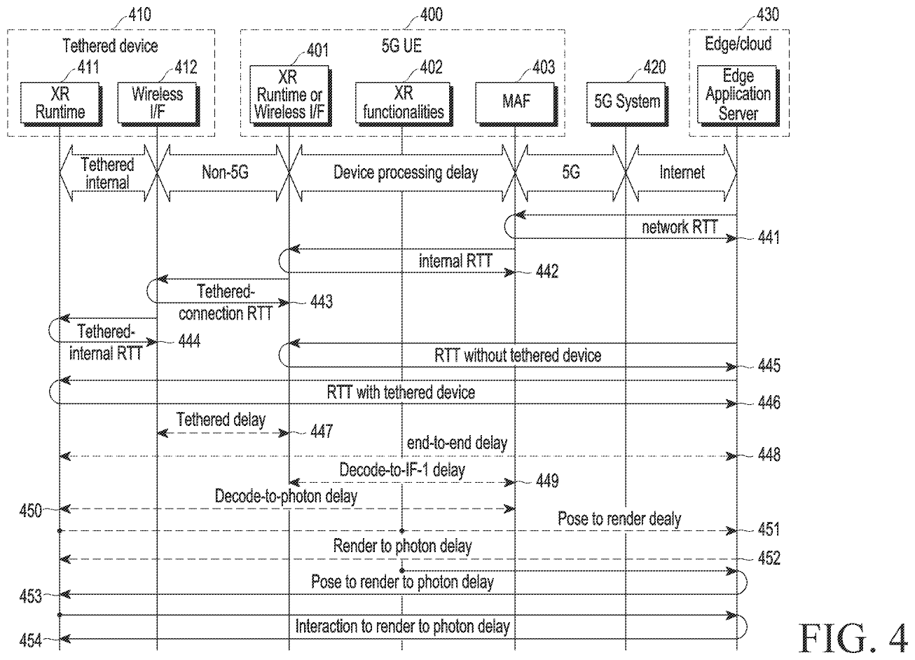

FIG. 5 is a view illustrating a round trip time (RTT) and delay between entities constituting a communication system when an accessory UE (tethered device) is not connected to a UE (tethering device) according to an embodiment of the disclosure.

Referring to FIG. 5, NetworkRTT may denote the network round trip time (RTT) or communication delay in the Internet section and the mobile communication network system (5G) section between the server 530 and the UE (e.g., the media access function (MAF) 503) required for completing reception of a result after data is transmitted between the server 530 and the UE (5G UE) 500 (541).

InternalRTT may denote the UE internal processing delay (device processing delay), e.g., the delay between the XR runtime module (or wireless interface (IF)) 501, XR functionalities 502, and the media access function (MAF) 503 inside the UE (5G UE) 500, required for completing reception of a result after data is transmitted between the server 530 and the UE (5G UE) 500 (542).

RTT delay may denote the end-to-end delay 544 required for completing reception of a result after data is transmitted between the server 530 and the UE (5G UE) 500 (543).

Decode-to-photon-delay denotes the time required for post-processing (e.g., decoding, scene composition, combination, adjustment, etc.) required by the UE (5G UE) 500 to use the corresponding media component received from the server 530 when there is no accessory UE (tethered device) (545).

Pose-to-render-delay includes the UE-server transmission delay time and the internal processing time of the UE (5G UE) 500 as the pose is predicted by the UE (5G UE) 500 (546).

Render-to-photon-delay denotes the time until the rendered media frame is transmitted to the server 530 and the UE (5G UE) 500 and undergoes processing in the UE (5G UE) 500 and then is output. Photon, although denoting the state in which, e.g., the pixel is visually lighted on, means the time when a media component is output for consumption, such as audio or haptic (547).

Pose-to-render-to-photon-delay includes the pose-to-render-delay and the render-to-photon-delay (548).

Interaction-to-render-to-photon-delay means the time when the user or external interaction event input from the UE (5G UE) 500 is transferred to the server 530 and is received as a result of the media component, and is output back to the UE (5G UE) 500 (549).

FIG. 6 is a view illustrating a communication method considering a tethered delay according to an embodiment of the disclosure.

Referring to FIG. 6, a mobile communication network system 630 and a UE 600 may perform a configuration operation for transmitting a QoE report (or a QoE metrics report) (641). More specifically, an application server 631 (hereinafter, server) of the mobile communication network system 630 may perform the operation. The UE (tethering device) 600 and the server 632 may determine scheduling for QoE report transmission in the process of session establishment, and the server 632 may transmit scheduling information for measuring a delay to the UE (tethering device) 600. When determined to be necessary at the time when the UE (tethering device) 600 connects or disconnects the accessory UEs (tethered devices) 610, it may be transmitted earlier than the scheduled time.

The UE (tethering device) 600 and the accessory UE (tethered device) 610 may generate a QoE report by measuring a tethered delay, etc. (642), and the UE (tethering device) 600 may transmit the QoE report to the mobile communication network system 220 (643). This is as described above with reference to FIGS. 2A and 2B.

The mobile communication network system 630 (e.g., the server 632) may analyze the tethered delay and select a policy based on the QoE report (644). When the server 632 receives a QoE report in which items related to the accessory UE (tethered device) 610, such as tethered-connection RTT item, are additionally described together with the networkRTT, the server 632 may determine that one or more media components are consumed through the accessory UE (tethered device) 610 in the tethering device 600 consuming the media service, and may increase the time when the media service is predicted to be expressed to the user by the tethered delay value.

More specifically, when there are tethered-connectionRTT and tetheredDeviceInformation items, the server 632 receiving the QoE metrics report from the UE (tethering device) 600 determines that the UE (tethering device) 600 is connected with the accessory UE (tethered device) 610 for the consumption of the provided media, and in particular, determines what transmission characteristics of non-3GPP access network connection for each media component it is transmitted to. Further, through the determination of the Decode-to-IF1-delay and the Decode-to-photon-delay in the mediaProcessingDelay information, the component of the time between the time when the media is provided by the server 632 and the time when it is consumed by the user may be determined.

First, the server 632 may determine the total time until the media provided by the server 632 is output from the UE (tethering device) 600 in consideration of UE-server delay characteristics (networkRTT and pose-to-render-delay) and UE processing and output time (internalRTT and Decode to photon delay). When the information about the tethered device 610 is provided, the server 632 may determine the UE processing time (Decode to IF1 delay) and the output time (Decode to photon delay) for each media component.

The server 632 may transmit the delay-related requirement (e.g., the maximum allowed delay time or the over-delay policy) corresponding to the metadata together with the media play entry (645).

The UE (tethering device) 600 and the mobile communication network system 630 (e.g., the server 632) may configure mobile communication network system functionalities (5G functionalities) (646). According to an embodiment, the UE (tethering device) 600 and the server 632 may select a QoS transmission (flow) of higher performance having a high transmission bitrate and lower delay so as to the RTT value which is the server-UE transmission which is a value controllable by the mobile communication system in a state in which enhancement may not be guaranteed although tethered delay information is grasped.

According to another embodiment, the server 632 may select a media profile to reduce the processing time in the UE and the server-UE transmission time. RTT and media post-processing time in the UE may be reduced when exchanging to a media profile using, e.g., better quality, lower resolution, lower bit depth, and higher-efficiency codec for the same media type (e.g., 2D video).

According to another embodiment, the server 632 may achieve an enhancement to require a shorter post-processing time in the UE by rather transmitting further additional information which may aid in, e.g., image analysis and 3D conversion, such as outline detection performed by the UE (tethering device) 600, such as different media types (e.g., 2D video and depth map).

According to another embodiment, the server 632 may instruct to allow the media frame transmitted from the UE (tethering device) 600 to the accessory UE (tethered device) 610 to use a lower quality, lower resolution, lower bit depth, and higher-efficiency codec or to have more strict delay requirements. When the UE (tethering device) 600 operates the delay requirements specified or indicated by the server 632 for the accessory UE (tethered device) 610, the UE (tethering device) 600 may perform post-processing not to exceed the predetermined delay time.

According to another embodiment, the server 632 may set a delay requirement in the area of the five senses detected by a person for a specific media component. For example, since a person has a very low allowed delay time for the tactile sense, if a tactile sense is felt within 10 ms for a visually input event, the person may accept it as a stimulus for the event, whereas if a tactile sense is felt after a delay larger than 20 ms, the person may accept it as a stimulus for a separate event. Since the allowed delay time of the visual sense is larger than the tactile sense by about 20 ms and the allowed delay time of the auditory sense is larger than the visual sense by about 100 ms, each media component may have a different allowed delay time, and the server 632 may specify and transmit the same, so that the UE (tethering device) 600 may apply a policy according to the delay for each accessory UE (tethered device) 610 indicated by the server 632.

According to another embodiment, even the same media component may include a media component that needs to be synchronized with the temporal and spatial locations of the user using the UE (tethering device) 600 and the accessory UE (tethered device) 610, and a media component that need not. Since this difference in context may not be identified by the UE (tethering device) 600, the server 632 may separately specify some media components that would cause no problems even when not synchronized although there is a target time for reproduction, and other media components that need to have a high level of synchronization.

For example, non-diegetic media components (e.g., the movie director's narration or background music or such sounds not heard by the leading roles of the movie) or on-screen display (OSD) screen (an image overlapping the screen figure, e.g., AR advertisement image not directly related to the AR navigation) in the content, such as an AR navigation using the accessory UE and the UE do not cause any problem although transmission is delayed.

In contrast, 6 degrees of freedom (6DoF) (which is for motions including horizontal, vertical, depth, slope, height, and rotation and denotes a scheme constituting VR and is a target of direct content to be considered in the navigation) or diegetic media components (which are images to be precisely mapped to the space, effect sounds) have strict delay requirements.

For the above reasons, the server 632 may specify policies according to the delay and different delay requirements according to the media to be transmitted, the media components constituting the media, or the type of the media component.

The UE (tethering device) 600 may establish a policy for the accessory UE (tethered device) 610 based on the media, media components, and delay-related requirements (e.g., the maximum allowed delay time or policy according to the delay) for the type of media component, received from the server 632 (647). Accordingly, the server 632 may have visibility and control right for the connection context after the UE (tethering device) 600 and may thus establish a policy for guaranteeing QoS including the transmission path which is not guaranteed for QoS.

Thereafter, the UE (tethering device) 600 may measure the tethered delay with the accessory UE (tethered device) 610 (648), as described above in operation 230 of measuring the tethered round trip time (tetheredRTT) illustrated in FIG. 2A.

The UE (tethering device) 600 may process the media signal based on the delay-related requirement (649). The delay-related requirement may include at least one of a maximum allowed delay time (maxAllowedDealy) or an over-delay policy.

The UE (tethering device) 600 may operate a limit value of the delay buffer for the media and the media component differently for each media component based on the received entire delay requirement, and manage a policy for a case of exceeding the maximum limit of the allowed delay for each tethering connection and media component.

The policy regarding the tethered delay for the media or media components delegated to the UE (tethering device) 600 by the application provider through the server 632 along with reception of the media may include, e.g., ‘drop,’ ‘correct,’ ‘rest,’ and ‘ignore.’

‘Drop’ is a policy that does not output the corresponding media frame when the presentation time of the corresponding media frame is past the maxAllowedDelay. ‘Correct’ is a policy that outputs the corresponding media frame at a next frame output time when the presentation time of the corresponding media frame is past the maxAllowedDelay. However, since the corresponding media frame may be temporally or spatially invalid, it may be output with the output space deformed or temporally advanced form (e.g., motion prediction compensation using a motion flow) applied. For example, for a target which has motion, such as a vehicle, as well as a fixed area such as a street or a road, in a 2D video captured for a street, this may be determined as a local search region (LSR), and the space may be deformed using the temporal continuity of the motion or the next frame in the temporally advanced form may be predicted and output.

‘Rest’ is a policy that outputs the corresponding media frame even during the remaining presentation duration of the corresponding media frame when the presentation time of the corresponding media frame is past the maxAllowedDelay. ‘Ignore’ is a policy that outputs the media component as soon as output is ready regardless of whether the maxAllowedDelay is indicated, with the maxAllowedDelay ignored.

Additionally, ‘accelerate’ is a policy that offsets the delay time by changing the UE execution speed for processing of a delayed media frame.

The delay-related requirement for the media or media component delegated to the UE (tethering device) 600 from the application provider through the server 632 includes information about priority. When the UE (tethering device) 600 identifies that there is priority information about the media component, the UE (tethering device) 600 determines whether to apply a delay policy for other media components with respect to the media component of the highest priority. In other words, the other media than the media of the high priority, although delayed, is reproduced using the counterpart's presentation time.

In an embodiment, it is assumed that in media constituted of haptic and audio and video media components, the maximum allowed delay time (maxAllowedDelay) is designated as 10 ms, 20 ms, and 100 ms, and the priority as 3, 2, and 1, in which the smaller number denotes the higher priority. When the transmission delay with the accessory UE (tethered device) in charge of video exceeds 100 ms in the context where haptic and audio are reproducible, the UE (tethering device) may adjust the clock of the total presentation time so that other media components may be reproduced after identifying that transmission of the video media component is secured. As the clock is readjusted, the user may recognize that media reproduction temporarily pauses or slows down, but other media components may be synchronized and reproduced with respect to the media component of the highest priority.

In an embodiment, the UE (tethering device) 600 reviews whether it is possible to offset the maxAllowedDelay by reducing the UE post-processing time in performing the delay-related policy or the maximum allowed delay time (maxAllowedDelay) received from the server 632. Output data may be generated faster by increasing the CPU/GPU time allocated for the post-processing process or increasing the central processing unit (CPU)/graphical processing unit (GPU) operation clock, and the output data may be transmitted to the accessory UE (tethered device) 610 as early as that to offset the tetheredDelay. The UE (e.g., the non-3GPP access network interface 601) 600 may transmit a media frame buffer to the accessory UE (tethered device) 610 based on the delay-related requirement (650). The tethering device 600 may also include an application 602 and a MAF 603.

When the session description protocol (SDP) is used as a protocol method for messages exchanged between the UE and the server, information considering a tethered delay may be included in the factor of m-line in the SDP.

For example, in an XR service including one or more tethered devices, the user may use multiple devices, typically UEs (or tethering devices) having 5G modem functionality and use one or more accessory UEs (tethered devices) tethered to the UE (tethering device), such as AR glasses or headsets. The accessory UE (tethered device) may connect to the UE (tethering device) and the mobile communication network using different connection technologies (e.g., Wi-Fi, Bluetooth, or 5G sidelink), and such connections may cause delay times different from the other tethering connections.

The UE (or tethering device) may include information related to the tethering device delay requirements for corresponding media to be consumed by the tethered accessory UE (tethered device) in the m-line factor in the SDP message received by the UE through the server when establishing an MTSI session with another multimedia telephony service for Internet protocol (IP) multimedia subsystem (IMS) (MTSI) client, e.g., another UE or media resource function (MRF).

In this situation, the tethered information attributes may indicate, to the transmission MTSI client, that the corresponding media lines have additional tethering delay requirements, which may be shown as in Table 6.

```
TABLE 6
  Tethered-info=“a” “=” “3gpp_tethered_info” “:” “ID-value” “,”
“tethered-latency” “policy-type”
  ID-value = “0” / “1” / “2” ...
  tethered-latency = range / integer
  policy-type = drop / correct / rest / ignore.
```

ID-value may be expressed as an integer value, corresponds to the identifier of the accessory UE (tethered device), and the identifier should be the same unique value for all media lines and MTSI session when it corresponds to the same given accessory UE (tethered device).

Tethered-latency is given in milliseconds and corresponds to a delay wait time requirement for the given accessory UE (tethered device). This value is estimated and determined by the MTSI client including/using the accessory UE (tethered device) and relies on the used connection technology, type of media to be consumed, and other implementation factors. Alternatively, the delay value may be given as a range using two values.

Policy-type is information about the delay-related policy and may include ‘drop,’ ‘correct,’ ‘rest,’ and ‘ignore’ which have been described above in detail.

Notifying the transmission MTSI client of the tethered delay time as described above may allow the reception part to compensate for the tethered delay time via a means such as scheduling of higher priority or multiplexing or other means through implementations.

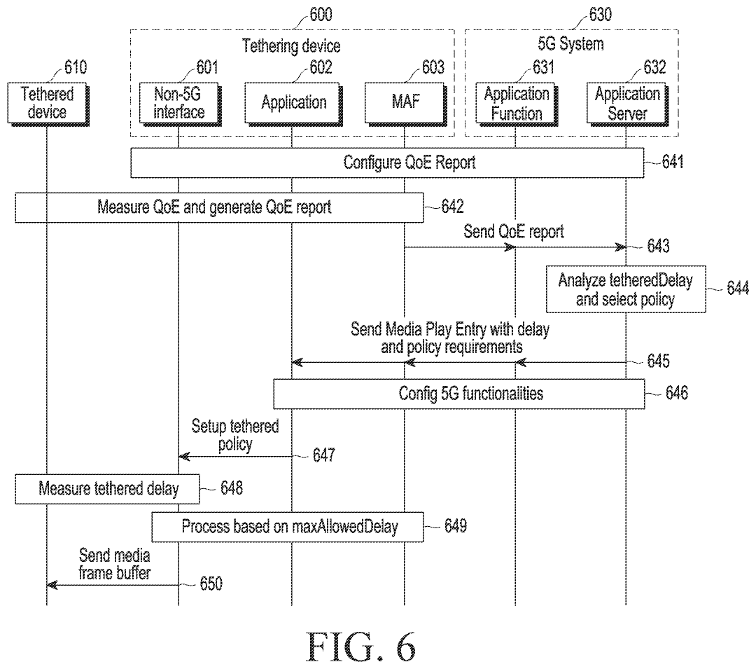

FIG. 7 is a block diagram illustrating a configuration of a UE and an accessory UE in a communication system according to an embodiment of the disclosure.

Each of the UE (or tethering device) and the accessory UE (tethered device) described in connection with FIGS. 1, 2A, 2B, and 3 to 6 may correspond to the UE of FIG. 7. Referring to FIG. 7, the UE may include a transceiver 710, memory 720, and a controller 730.

The transceiver 710, controller 730, and memory 720 of the UE may operate according to the above-described communication methods by the UE. However, the components of the UE are not limited thereto. For example, the UE may include more or fewer components than the above-described components. The transceiver 710, the controller 730, and the memory 720 may be implemented in the form of a single chip. The controller 730 may include one or more processors.

The transceiver 710 collectively refers to a transmitter of the UE and a receiver of the UE and may transmit and receive signals to/from another device. To that end, the transceiver 710 may include a radio frequency (RF) transmitter for frequency-up converting and amplifying signals transmitted and an RF receiver for low-noise amplifying signals received and frequency-down converting the frequency of the received signals. However, this is merely an example of the transceiver 710, and the components of the transceiver 710 are not limited to the RF transmitter and the RF receiver.

The transceiver 710 may receive signals via a radio channel, output the signals to the controller 730, and transmit signals output from the controller 730 via a radio channel.

The memory 720 may store programs and data necessary for the operation of the UE. The memory 720 may store control information or data that is included in the signal obtained by the UE. The memory 720 may include a storage medium, such as ROM, RAM, hard disk, CD-ROM, and DVD, or a combination of storage media. Rather than being separately provided, the memory 720 may be embedded in the controller 730.

The controller 730 may control a series of processes for the UE to be able to operate according to the above-described embodiments.

The controller 730 according to an embodiment may receive, from a server, scheduling information for generating communication delay information upon transmitting media to a second UE, measure a communication delay with the first UE and the second UE based on the scheduling information, generate the communication delay information based on the measured communication delay, and control to transmit the communication delay information to the server.

According to an embodiment, a first communication technology used to connect the first UE and the second UE may differ from a second communication technology used to connect the first UE and the server. Further, the controller 730 may control to measure an internal processing delay of the first UE. The communication delay information may include information about the measured internal processing delay of the first UE. Further, the communication delay information may include an identifier (ID) for the second UE and a media component ID included in the media.

According to an embodiment, the controller 730 may control to receive a delay-related requirement based on the communication delay information from the server. The delay-related requirement may include at least one of a maximum allowed delay time or an over-delay policy. Further, the delay-related requirement may further include information about transmission priority between a plurality of media components included in the media.

In the disclosure, for convenience of description, the UE (tethering device) described above in connection with FIGS. 1, 2A, 2B, and 3 to 6 may be referred to as a first UE, and the accessory UE (tethered device) may be referred to as a second UE.

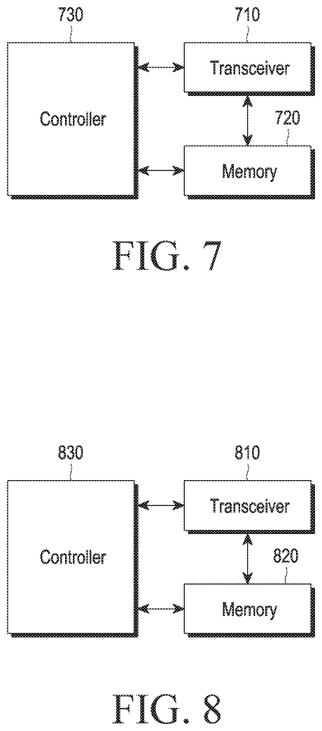

FIG. 8 is a block diagram illustrating a configuration of a server in a communication system according to an embodiment of the disclosure.

Each application server (or server) in the mobile communication system described in connection with FIGS. 1, 2A, 2B, and 3 to 6 may correspond to the server of FIG. 8. Referring to FIG. 8, the server may include a transceiver 810, memory 820, and a controller 830.

The transceiver 810, controller 830, and memory 820 of the server may operate according to the above-described communication methods by the server. However, the components of the server are not limited thereto. For example, the server may include more or fewer components than the above-described components. The transceiver 810, the controller 830, and the memory 820 may be implemented in the form of a single chip. The controller 830 may include one or more processors.

The transceiver 810 collectively refers to a transmitter of the server and a receiver of the server and may transmit and receive signals to/from another device. To that end, the transceiver 810 may include a radio frequency (RF) transmitter for frequency-up converting and amplifying signals transmitted and an RF receiver for low-noise amplifying signals received and frequency-down converting the frequency of the received signals. However, this is merely an example of the transceiver 810, and the components of the transceiver 810 are not limited to the RF transmitter and the RF receiver.

The transceiver 810 may receive signals via a radio channel, output the signals to the controller 830, and transmit signals output from the controller 830 via a radio channel.

The memory 820 may store programs and data necessary for the operation of the server. The memory 820 may store control information or data that is included in the signal obtained by the server. The memory 820 may include a storage medium, such as ROM, RAM, hard disk, CD-ROM, and DVD, or a combination of storage media. Rather than being separately provided, the memory 820 may be embedded in the controller 830.

The controller 830 may control a series of processes for the server to be able to operate according to the above-described embodiments.

The controller 830 according to an embodiment may transmit, to a first UE, scheduling information for generating communication delay information upon transmitting media to a second UE through the first UE and control to receive the communication delay information from the first UE. The communication delay information may be generated based on a communication delay with the first UE and the second UE measured based on the scheduling information.

According to an embodiment, a first communication technology used to connect the first UE and the second UE may differ from a second communication technology used to connect the first UE and the server. Further, the communication delay information may include information about the internal processing delay of the first UE and may include an identifier (ID) for the second UE and a media component ID included in the media.

According to an embodiment, the controller may transmit a delay-related requirement based on the delay information to the first UE. Required information about communication delay management may include at least one of a maximum allowed delay time or an over-delay policy for the media transmission. Further, the delay-related requirement may further include information about transmission priority between a plurality of media components included in the media.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first user equipment (UE) managing communication delay in a communication system, the method comprising:
receiving, from a server, scheduling information for generating communication delay information upon transmitting media to a second UE;
measuring a communication delay with the first UE and the second UE based on the scheduling information;
generating the communication delay information based on the measured communication delay; and
transmitting, to the server, the communication delay information.

2. The method of claim 1, wherein a first communication technology used to connect the first UE and the second UE differs from a second communication technology used to connect the first UE and the server.

3. The method of claim 1, wherein the communication delay information includes at least one of information about internal processing delay of the first UE, an identifier (ID) for the second UE, or a media component ID included in the media.

4. The method of claim 1, further comprising:
receiving, from the server, a delay-related requirement based on the communication delay information,
wherein the delay-related requirement includes at least one of a maximum allowed delay time or an over-delay policy for the media transmission.

5. The method of claim 4, wherein the delay-related requirement further includes information about transmission priority between a plurality of media components included in the media.

6. A method performed by a server managing communication delay in a communication system, the method comprising:
transmitting, to a first user equipment (UE), scheduling information for generating communication delay information upon transmitting media to a second UE through the first UE; and
receiving, from the first UE, the communication delay information,
wherein the communication delay information is generated based on a communication delay with the first UE and the second UE, and
wherein the communication delay information is measured based on the scheduling information.

7. The method of claim 6, wherein a first communication technology used to connect the first UE and the second UE differs from a second communication technology used to connect the first UE and the server.

8. The method of claim 6, wherein the communication delay information includes at least one of information about internal processing delay of the first UE, an identifier (ID) for the second UE, or a media component ID included in the media.

9. The method of claim 6, further comprising:
transmitting, to the first UE, a delay-related requirement based on the communication delay information,
wherein the delay-related requirement includes at least one of a maximum allowed delay time or an over-delay policy for the media transmission.

10. The method of claim 9, wherein the delay-related requirement further includes information about transmission priority between a plurality of media components included in the media.

11. A first user equipment (UE) managing communication delay in a communication system, the first UE comprising:
a transceiver; and
at least one processor coupled to the transceiver and configured to:
receive, from a server, scheduling information for generating communication delay information upon transmitting media to a second UE,
measure a communication delay with the first UE and the second UE based on the scheduling information,
generate the communication delay information based on the measured communication delay, and
transmit, to the server, the communication delay information.

12. The first UE of claim 11, wherein a first communication technology used to connect the first UE and the second UE differs from a second communication technology used to connect the first UE and the server.

13. The first UE of claim 11, wherein the communication delay information includes at least one of information about internal processing delay of the first UE, an identifier (ID) for the second UE, or a media component ID included in the media.

14. The first UE of claim 11, wherein the at least one processor is configured to:
receive, from the server, a delay-related requirement based on the communication delay information,
wherein the delay-related requirement includes at least one of a maximum allowed delay time or an over-delay policy for the media transmission.

15. The first UE of claim 14, wherein the delay-related requirement further includes information about transmission priority between a plurality of media components included in the media.

16. A server managing communication delay in a communication system, the server comprising:
a transceiver; and
at least one processor coupled to the transceiver and configured to:
transmit, to a first user equipment (UE), scheduling information for generating communication delay information upon transmitting media to a second UE through the first UE, and
receive, from the first UE, the communication delay information,
wherein the communication delay information is generated based on a communication delay with the first UE and the second UE, and
wherein the communication delay information is measured based on the scheduling information.

17. The server of claim 16, wherein a first communication technology used to connect the first UE and the second UE differs from a second communication technology used to connect the first UE and the server.

18. The server of claim 16, wherein the communication delay information includes at least one of information about internal processing delay of the first UE, an identifier (ID) for the second UE, or a media component ID included in the media.

19. The server of claim 16, wherein the at least one processor is configured to:
transmit, to the first UE, a delay-related requirement based on the communication delay information, and
wherein required information about communication delay management includes at least one of a maximum allowed delay time or an over-delay policy for the media transmission.

20. The server of claim 19, wherein the delay-related requirement further includes information about transmission priority between a plurality of media components included in the media.
